(19) United States
(12) Patent Application Publication
(10) Pub. No.: US 2014/0009403 A1
(43) Pub. Date: Jan. 9, 2014

(54) System and Method for Creating Optimal Command Regions for the Hand on a Touch Pad Device

(71) Applicants: Christopher Tremblay, Cantley (CA); Caroline Sauve, Ottawa (CA); Vladimir Makarov, Kanata (CA)

(72) Inventors: Christopher Tremblay, Cantley (CA); Caroline Sauve, Ottawa (CA); Vladimir Makarov, Kanata (CA)

(73) Assignee: Corel Corporation, Ottawa (CA)

(21) Appl. No.: 13/543,691

(22) Filed: Jul. 6, 2012

(51) Int. Cl. G06F 3/041

(52) U.S. Cl. 345/173

(57) ABSTRACT

According to certain general aspects, the present invention relates to a method and apparatus for allowing commands for an application to be effectively and conveniently executed. In general embodiments, an application executed on a tablet computer automatically senses fingertips on the tablet and forms command regions around them. Commands are associated with the command regions, and when a touch event occurs in a command region (e.g. a finger tap), the information is sent to a client application possibly running on a remote host, where the associated command is executed.

### FIELD OF THE INVENTION

The present invention relates generally to user interfaces for computer applications, and more particularly to systems and methods for creating command regions on a touch pad device that are optimally and dynamically located according to the position and/or orientation of a person's hand.

### BACKGROUND OF THE INVENTION

Since the advent of personal computing devices, computer applications have become increasingly robust and powerful. However, along with such robust functionality, a robust set of commands to access such functionality is required, typically through drop down lists, menus and the like. Accordingly, efforts have been made to make such functionality easier to access.

Prior approaches to solving this problem include keyboard shortcuts and specialized buttons on interface devices (e.g. mice, keypads, Wacom tablets, etc.). The user normally can specify what commands are to be executed when a combination of keys are pressed on the keyboard or when specific buttons are pressed on the interface device.

One problem with these approaches is that the keyboard shortcuts are often not easy to remember (except for the most commonly used shortcuts).

In addition, there is not always text or images on the tablet buttons or keyboard to indicate what commands will be executed when buttons are pressed. Moreover, the user can't reposition the hardware buttons on keyboards or tablets, or change their size and shape, to be the most natural for their hand position for example.

A recent approach is Adobe's Nav, which is a companion application for Photoshop that runs on an iPad. It provides a set of buttons that when pressed on the iPad activate certain functions in Photoshop running on a separate computer. However, the set of buttons is fixed in size, shape and configuration, and a person needs to look away from the Photoshop screen and at the buttons to know what is pressed.

Accordingly, vast opportunities for improvement remain.

### SUMMARY OF THE INVENTION

According to certain general aspects, the present invention relates to a method and apparatus for allowing commands for an application to be effectively and conveniently executed. In general embodiments, an application executed on a tablet computer (e.g. iPad) automatically senses fingertips on the tablet and forms command regions around them. Commands are associated with the command regions, and when a touch event occurs in a command region (e.g. a finger tap), the information is sent to a client application possibly running on a remote host, where the associated command is executed.

According to certain other aspects, the present invention provides a method of creating one or more command regions based on individual touch areas. According to certain other aspects, the present invention provides a method of recognizing the hand configuration (hand detection left or right, and finger identification). According to certain other aspects, the present invention provides a method of creating one or more command regions based on recognized hand configuration. According to certain other aspects, the present invention provides a method of moving command regions as desired. According to certain other aspects, the present invention provides a method of auto-calibrating the command regions when the hand touches the device. According to certain other aspects, the present invention provides a method of dynamically updating the command regions (position, shape etc.) over time according to the hand position and gestures executed. According to certain other aspects, the present invention provides a method of locking certain commands, while having others updated when changing the set of commands associated with the command regions.

In accordance with these and other aspects, a method according to embodiments of the invention includes sensing locations of a plurality of contact points between portions of a hand and a touchpad; forming command regions around the sensed locations; and assigning commands to be executed when the hand makes gestures in the command regions.

In further accordance with these and other aspects, a system according to embodiments of the invention includes a touchpad; a display overlying the touchpad; and a touchpad application that is adapted to: sense locations of a plurality of contact points between portions of a hand and the touchpad; form command regions around the sensed locations; and assign commands to be executed when the hand makes gestures in the command regions.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIGS. 1A to 1E illustrate example configurations of a system according to embodiments of the invention;

FIGS. 2A and 2B illustrate example command regions associated with automatically detected fingertip contact areas;

FIG. 3 is a functional block diagram of an example system according to embodiments of the invention;

FIG. 4 is a flowchart illustrating an example methodology according to embodiments of the invention;

FIGS. 5A to 5D illustrate an example methodology of automatically identifying a hand and fingers on a pad device according to embodiments of the invention;

FIG. 6 is a flowchart illustrating an example methodology of associating commands with command regions on a pad device according to embodiments of the invention; and

FIG. 7 is a flowchart illustrating an example methodology of operating a client application using commands activated by touch events on a pad device according to embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to certain general aspects, the invention allows execution of commands remotely from a touch sensitive device such as an iPad. As the system detects an “execute command” event on the touch sensitive device, it forwards the event to a remote application or OS which is running on a different device (.e.g. PC, iOS device or other), which in turns handles the event and causes an associated command to perform a desired task on the remote device.

In embodiments, the invention can automatically recognize hand orientation and detect finger contact areas, and create associated command regions on the touch device. Command regions can be any shape (circular, elliptic, irregular shaped). They can be much bigger than the contact area or elongated and oriented in such a way as to allow the user's finger to move up or down (or slightly towards the centre of the hand) on the device and still be in contact with the command region. Command regions can display text and images or other information to inform the user as to what command is currently associated with it. There can be any number of command regions (there can be a one-to-one mapping for each finger that came in contact, there can be more than one command region per contact area or finger, or there can be less when some fingers are ignored for example). The actual number and configuration of the regions is something that the user can preferably control. The position and number of command regions can be fixed (e.g. calibrated once and on-demand by the user), automatic or adaptive (i.e. dynamic).

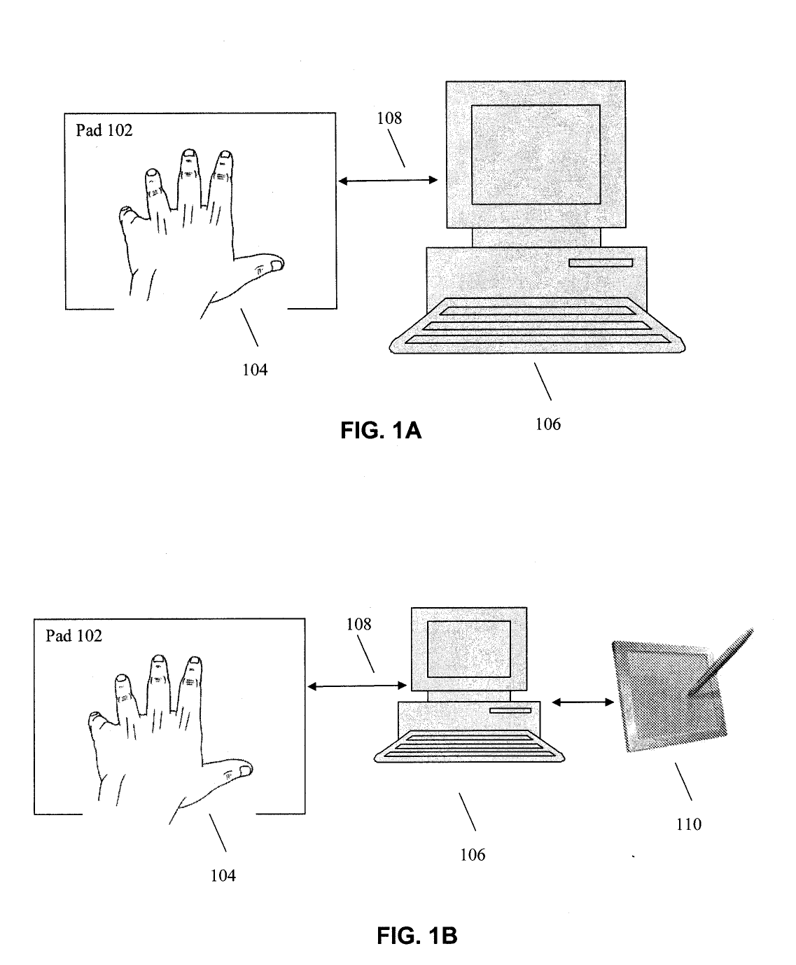

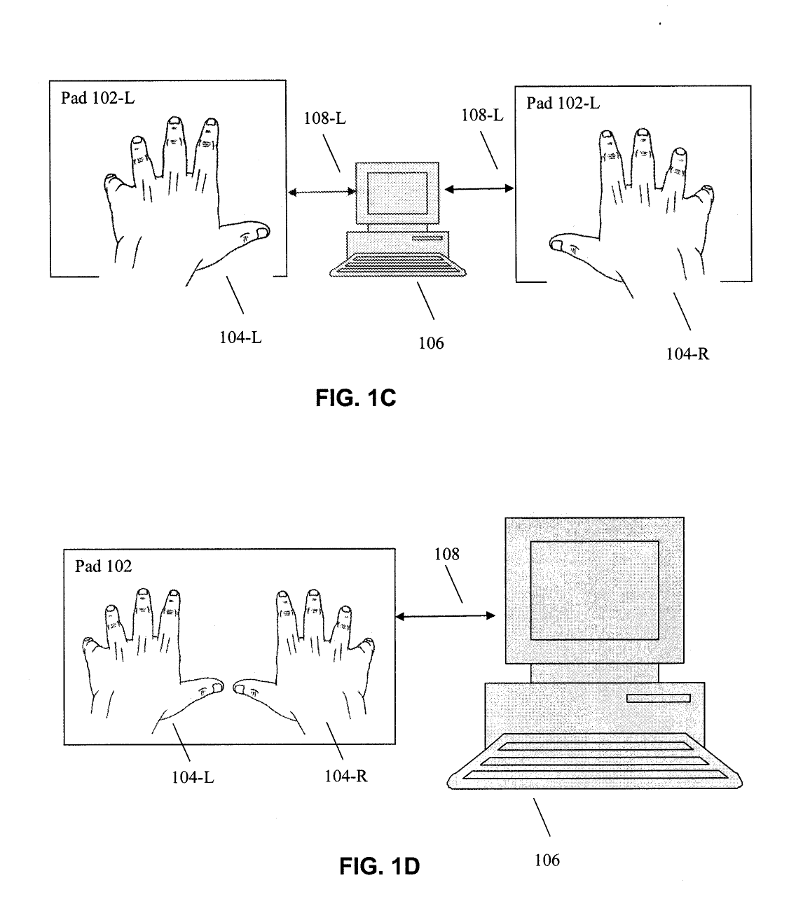

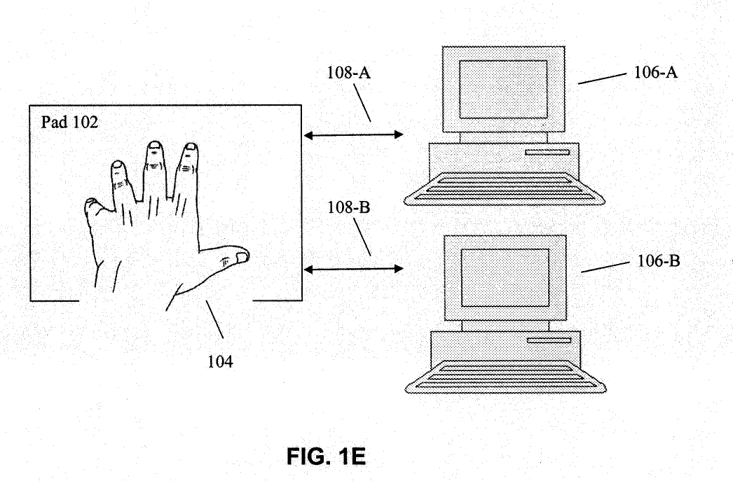

An example system in which embodiments of the invention can be included is shown in FIG. 1A. As shown in FIG. 1A, in general a system 100 includes a pad device 102 that senses gestures from a user's hand 104 through a touchscreen and the like. These gestures are captured and transmitted to a host device 106 via a connection 108 and used to control various tasks on host device 106.

Pad device 102 is, for example, a tablet or pad computer (e.g. an iPad from Apple Computer, Galaxy from Samsung, etc.). However, the invention is not limited to this example. Pad device 102 preferably includes a touchscreen or similar device that can simultaneously display graphics/text/video and sense various types of contacts and gestures from a person's hand (e.g. touches, taps, double taps, swipes, etc.) or stylus. In an example where the pad device 102 is an iPad, it executes an operating system such as iOS that includes various system routines for sensing and alerting to different types of contact on a touchscreen. An application running under iOS is installed on pad device 102 to implement aspects of the invention to be described in more detail below. Pad device 102 is not limited to tablet computers, but can include cellular phones, personal digital assistants (PDAs) or other devices, and those skilled in the art will understand how implementation details can be changed based on the particular type of pad device.

Host device 106 is generally any type of computing device that can host at least a client application that has a user interface that responds to and executes commands from a user (e.g. Corel Painter or CorelDRAW or Adobe Photoshop). In an example where host 106 is implemented by a personal computer such as a Mac, PC, notebook or desktop computer, host 106 typically includes an operating system such as Windows or Mac OS. Host 106 further preferably includes embedded or external graphical displays (e.g. one or more LCD screens) and I/O devices (e.g. keyboard, mouse, keypad, scroll wheels, microphone, speakers, video or still camera, etc.) for providing a user interface within the operating system and communicating with a client application. Host device 106 is not limited to personal computers, but can include server computers, game systems (e.g. Playstation, Wii, Xbox, etc.) or other devices, and those skilled in the art will understand how implementation details can be changed based on the particular type of host device.

The client application (e.g. Painter or Draw) preferably provides a graphical interface using the display of host 106 by which the user can perform desired tasks and see the results in real time (e.g. drawing on a canvas, etc.). As will be described in more detail below, such tasks can be controlled using the commands gestured by a user's hand 104, captured at pad device 102 and communicated to host 106 via connection 108.

The client application can also be similar to a device driver that allows the pad device 102 to interface with a plurality of different client applications (e.g. Word, Excel, etc.) like any other standard peripheral device such as a pen tablet, mouse, etc.

Connection 108 can include various types of wired and wireless connections and associated protocols, and can depend on the types of interfaces and protocols mutually supported by pad device 102 and host device 106. Wireless connections can include Bluetooth, WiFi, infrared, radio frequency, etc. Wired connections can include USB, Firewire, Ethernet, Thurderbolt, serial, etc.

It should be noted that the configuration shown in FIG. 1A is non-limiting and embodiments of the invention encompass many other possible configurations, including numbers of pad devices, inclusion of other peripheral devices, number of hands used per configuration, etc.

For example, FIG. 1B shows a configuration where one hand is operating a pad device 102 and the other hand is operating a different peripheral device 110, such as a Wacom tablet and stylus. This type of configuration may be preferred where host device 106 is hosting a painting application (e.g. Corel Painter or Adobe Photoshop), for example.

FIG. 1C shows another possible example configuration, where there are two pad devices 102-L and 102-R, one for each hand 104-L and 104-R having respective connections 108-L and 108-R to host device 106.

FIG. 1D shows yet another possible example configuration where pad device 102 senses and processes commands for two hands. In this regard, it should be noted that the detailed descriptions that follow will describe an example embodiment where only one hand is detected and used for associated command regions. However, those skilled in the art will understand how to implement the configuration shown in FIG. 1D after being taught by those example descriptions. Example applications in which the configuration of FIG. 1D can be used include personalized ergonomic keyboard applications and musical applications such as computer piano applications.

FIG. 1E shows yet another possible example configuration, where pad device 102 is simultaneously connected to two or more different host devices 106-A and 106-B via respective connections 108-A and 108-B. In this example configuration, pad device 102 can be used with different client applications and can have the ability to switch between controlling the different client applications. The commands can be sent to the selected client application, or all of the connected client applications at once (e.g. in a classroom environment or the like).

In an example embodiment to be described in more detail below, pad device 102 running an application according to the invention includes a full screen interface for associating command regions with the fingers of one hand.

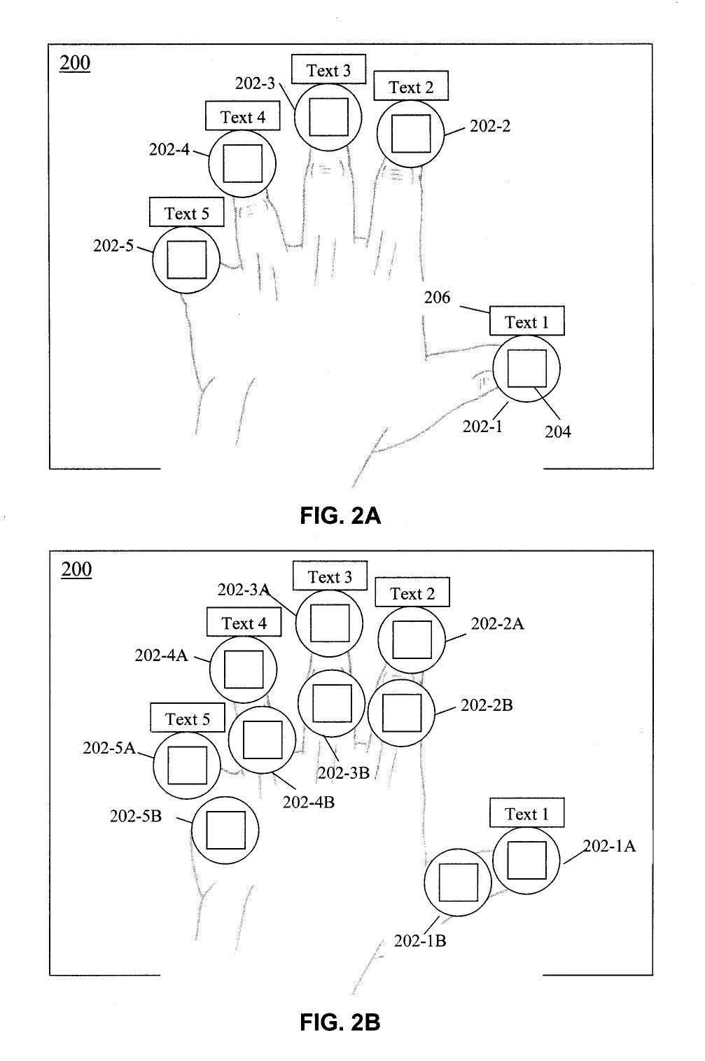

In one example configuration shown in FIG. 2A, a display area 200 of a touchscreen of pad device 102 is fully occupied by an application according to embodiments of the invention. However, this is not necessary and the application may only occupy a portion of the display area 200. In this example, the application associates a single contact region 202 with the finger tip of each identified finger of one hand. The contact region 202 is circular in this example, however other shapes are possible such as squares, rectangles, ellipses, etc., or even irregular shapes.

As further shown, associated with each command region 202 is an icon 204 that gives a visual representation of the command associated with the command region 202, as well as text 206 that provides a text description of the command associated with the command region 202.

In embodiments, a single event (e.g. a finger tap, a reverse tap, a finger swirl or swipe, etc.) within the command region 202 causes the associated command to be executed. However, it is possible that different events can cause the same command or respectively different commands to be executed.

FIG. 2B shows an alternative embodiment with more than one command region 202-1A and 202-1B associated with each finger. In this example, one command region can be associated with a finger fully extended, and another is associated with the finger bent. It should be apparent that many alternatives are possible, such as different fingers having different number(s) of command regions, and for different types of finger states (e.g. for finger bent, finger extended, finger angled right or left, etc.).

Although the embodiments of the invention will be described in detail in connection with input events associated with one fingertip (e.g. taps, swirls, swipes, etc.), the invention is not limited to these types of events. For example, embodiments of the invention could further associate command regions and events with multi-finger swipes (e.g. at a top, bottom or side portion of the display), two-finger gestures such as zooming in and out, a palm tap, a tap with the side of a hand, a wrist twist (i.e. thumb and opposite side of hand tapping the device in quick sequence), etc. Such gestures can be detected or configured using built-in features of the pad device 102 (e.g. iOS Touch Events), or can be customized and built on top of primitive events included in such built-in features.

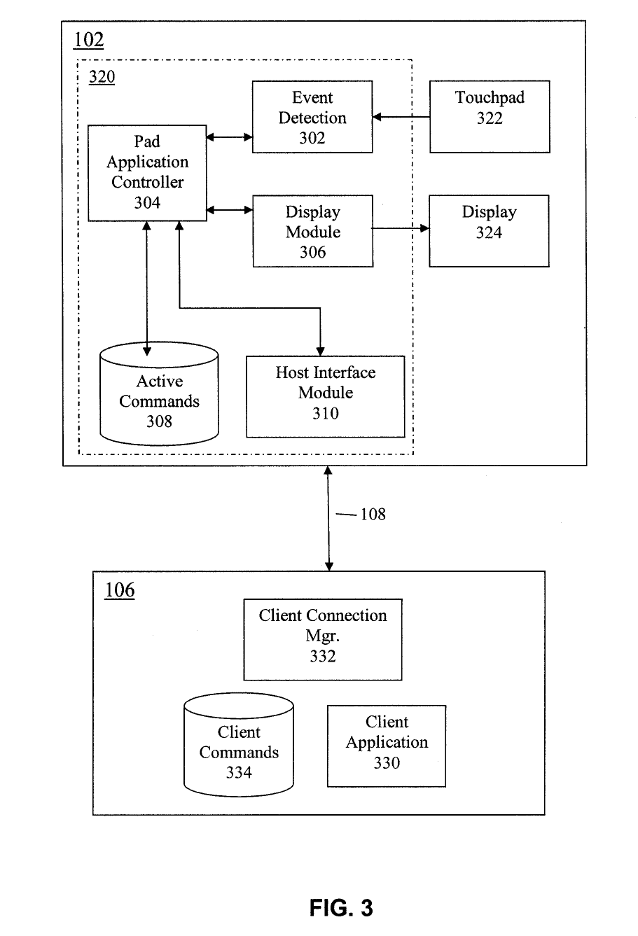

A functional block diagram illustrating an example system 100 such as that shown in FIG. 1 in alternative detail is shown in FIG. 3.

As shown, pad device 102 includes a pad application 320, a touchpad 322 and a display 324. In this example embodiment, pad application 320 includes a touch event detection module 302, pad application command control module 304, a display module 306, an active command configuration list 308, and a host interface module 310.

Event detection module 302 detects events from touchpad 322 such as finger taps, etc. In an example embodiment where pad device 102 is an iPad, event detection module 302 hooks into iOS Touch Events and builds upon the events automatically captured at the system level. The events used and managed by pad application 320 can directly incorporate events captured by iOS Touch Events (e.g. taps), but can also include custom events built upon such system level events (e.g. reverse tap).

Display module 306 renders images for display 324, such as command regions and associated text and icons. In an example where pad device 102 is an iPad, display module 324 can use iOS rendering APIs.

Command control module 304 provides overall management and control of pad application 320, including configuring active command list 308, and controlling actions based thereon. Aspects of this management and control functionality will become more apparent from further detailed descriptions below. Command control module 304 also manages communication with host device 106 via host interface module 310.

Active commands list 308 includes the current configuration of command regions, their locations, sizes and shapes, the commands associated with them, the gestures associated with activating the commands, etc.

Host interface module 310 handles direct communications with host device 106, in accordance with the type of connection 108. In an example where connection 108 is a Wi-Fi connection, interface module 310 uses standard and proprietary WiFi, communications to interface with host device 108.

FIG. 3 also illustrates an example configuration of host device 106 in embodiments of the invention. As shown in FIG. 3, host device 106 includes a client application 330. In an example embodiment where device 106 is a Mac or PC, application 330 is a digital art software program such as Corel Painter or Adobe Photoshop running under MacOS or Windows. However, the invention is not limited to this example embodiment, and client application 330 can include a wide variety of software programs that have user interfaces.

As further shown in FIG. 3, in one possible example where application 330 is a digital art software program 330, it further includes a set of client application commands 334. In a typical example, these commands can be accessed via menus, drop-down lists, popups, etc. in a standard graphical user interface using mouse clicks, keyboard shortcuts and the like. However, to allow such commands to be additionally or alternatively accessed via pad device 102, in this embodiment client application 330 includes a connection manager 332 that allows certain or all of the available commands 334 to be further configured and/or executed by pad device 102. This can be done by directly modifying the user interface of the program, or using existing APIs for a given client application such as those available in the Adobe Photoshop Connection SDK. Those skilled in the art will appreciate how to adapt a client application with such functionality after being taught by the following example descriptions. Moreover, those skilled in the art will appreciate that various types of alternative embodiments are possible, such as having a standalone application (e.g. a device driver) on host device 106 that allows pad device 102 to interact with many different client applications via a common interface, like any other peripheral I/O device such as a mouse or tablet device.

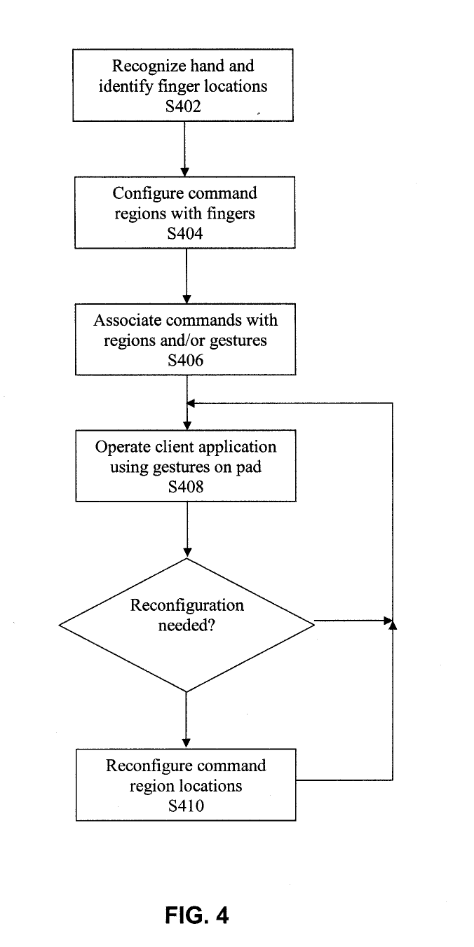

An overall example methodology associated with pad device 102 will be explained in connection with the flowchart in FIG. 4.

As shown, in step S402 a method according to embodiments of the invention can automatically detect which hand is placed on the pad device (left or right), and identify the locations of specific fingers. This allows specific commands to be positioned under specific fingers for better usability.

In a next step S404, embodiments of the invention can position command regions using local information. For instance, the command region center can be placed directly under the touch area or within a certain distance from the touch area. Alternatively, using global information of the hand position (and all the fingers), the system can position command regions at specific positions that make sense. For instance, command regions can be created under the fingers, but also just above and just below the index finger contact area, following an angle that goes towards the center of the hand. In some embodiments, the user is allowed to further edit the shape, size and/or location of the command regions.

In a next step S406, embodiments of the invention can associate commands to be executed when a gesture (e.g. a finger tap) is detected in each of the command regions. In some embodiments, this step can include downloading a set of available commands from a client application. In other embodiments, the user can select which commands are associated with each command region. In embodiments, a predetermined set of commands is used. In other embodiments, multiple commands can be associated with the same command region. Moreover, in some embodiments, only a single gesture (e.g. finger tap) can be configured. In other embodiments, multiple gestures (e.g. finger taps, reverse taps, swipes, etc.) can be configured, perhaps for the same command region. For example, executing a tap gesture and a swipe gesture on the same command region would invoke two different commands. In other embodiments, where there are more commands than there are gestures associated with the same command region, the invention may provide further means for the user to select which of the commands to execute. For example, if there are two commands and one tap gesture associated with the same command region, and the user taps on the command region, the invention may provide two options for the user to choose from, one for each command (e.g. on the display of the pad device 102 or host device 106).

In step S408, a user can operate a client application using the configured commands on the pad device 102. In this step, pad device 102 senses events (e.g. finger taps, etc.) on the touch pad, associates the command region where the event was sensed to the configured command, and sends the command to the host device 106. The client application on the host device 106 can then execute the command.

As further shown in step S410, the command regions can be reconfigured if needed for subsequent operations. In embodiments, command regions can be adjusted over time as the system adapts to the user's hand position (i.e. the touch positions of the fingertips) and/or the locations of gestures such as taps dynamically. For example, it can shift the position of the command region if the user is always tapping towards an edge of the region. In the example shown in FIG. 4, the application periodically (e.g. after a predetermined number of gestures or commands) determine whether command regions should be adjusted (e.g. based on a deviation of touch positions or taps landing away from the center of a command region exceeding a given threshold). If so, the position, size or shape of the command region can be updated.

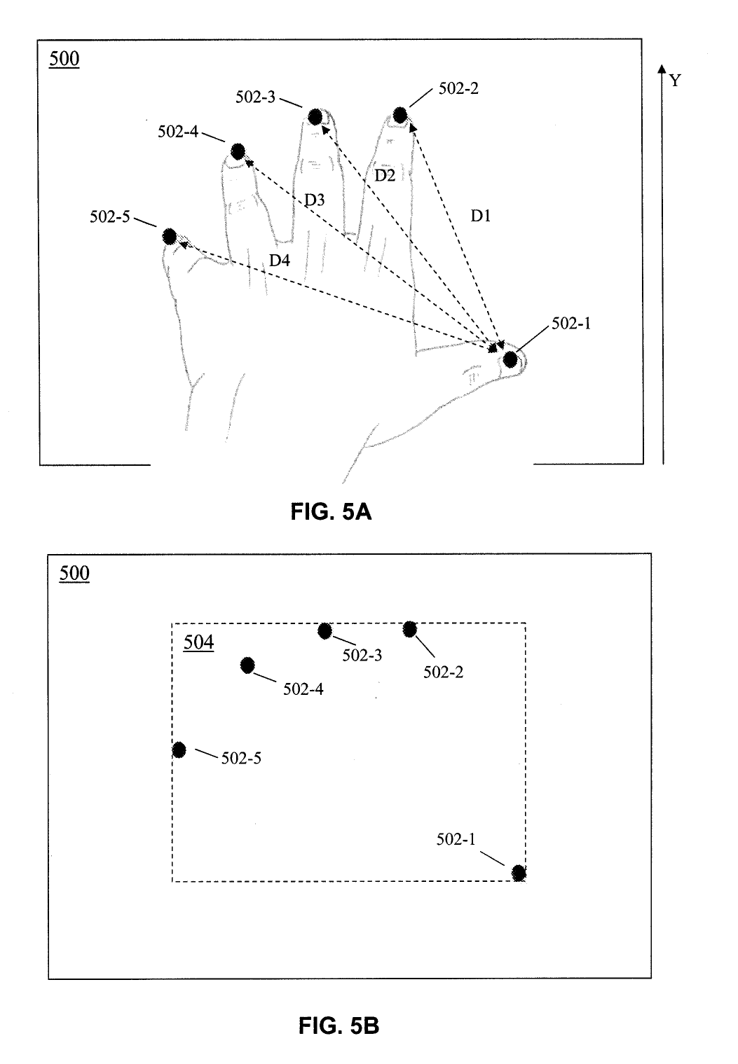

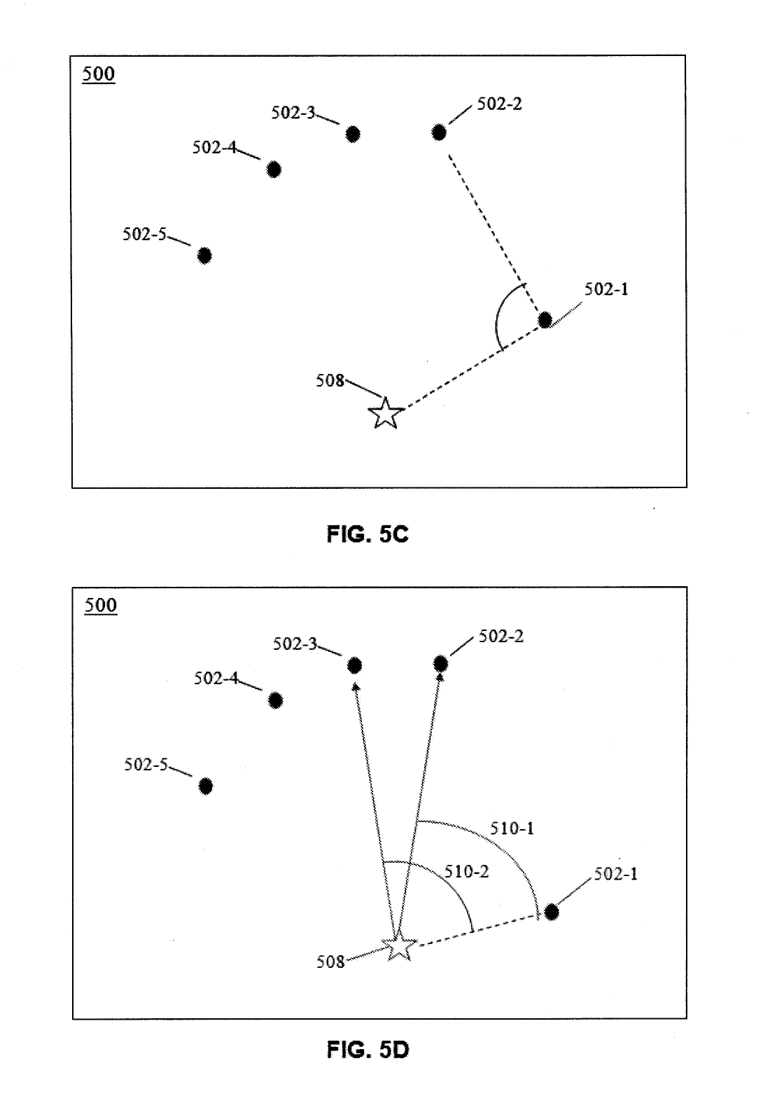

An example method of recognizing a hand and fingers according to embodiments of the invention is described in more detail below in connection with FIGS. 5A-5C.

In one example embodiment, a user initiates a hand recognition process using a dedicated command in a pad application 320 on pad device 102. In response to the command, the pad application can prompt the user to place all five fingertips on the touchscreen. In connection with this, the application may provide a display of an outline of a hand to guide or prompt the user. In other embodiments, the recognition process is commenced automatically whenever the user places a hand on the pad device.

When the application senses five separate contact points 502-1 to 502-5 from the fingertips simultaneously pressing on the touchscreen, or collected in sequence, hand recognition processing begins. First, as shown in FIG. 5A, the application identifies the thumb. For example, the application identifies the Y coordinate of each contact point 502-1 to 502-5. The application further identifies the average distance between each contact point and the other four contact points (e.g. the average of distances D1 to D4 for each of the five contact points 502-1 to 502-5). The contact point 502 having both the lowest Y coordinate and the minimum average distance between the other contact points is identified as the thumb 502-1.

Next, as shown in FIG. 5B, the application determines whether the fingers belong to a left or right hand. For example, as shown in FIG. 5B, the application draws a bounding rectangle 504 around the five identified contact points. Having already identified contact point 502-1 as belonging to the thumb, the hand (i.e. left or right) is determined based on which edge of the rectangle it lies (i.e. right or left).

Next, the application identifies all the fingers. For example, as shown in FIG. 5C, starting with the thumb contact point 502-1, the next closest contact point 502-2 is identified using distances computed previously. A vertical axis is then determined by these two points, with the thumb at the origin. Point 502-2 is then rotated 90 degrees (counterclockwise for the left hand and clockwise for the right hand). The result of this rotation gives the position of a point 508, which is anatomically close to the center of the hand. Next, as shown in FIG. 5D, using this point 508 as the center, the angles 510 between the thumb and each of the contact points 502-2 to 502-5 are computed. The fingers are thus identified in ascending order of the angle magnitude. In other words, the index finger is associated with the contact point 502-2 having the first lowest angle 510-1, the middle finger is associated with the contact point 502-3 having the next lowest angle 510-2, etc.

After identifying the hand and fingers, the application can provide visual indications of all the associated command regions. In one example, the application simply draws a circle having a predetermined radius around each identified contact point 502 to define a single command region for each finger. The application further inserts text to identify the finger (i.e. thumb, index, etc.). At this point, the application can also prompt the user to accept this identification, at which point the command regions can become fixed.

Additionally or alternatively, the application can allow the user to edit the positions, shapes, etc. of the command regions. The user could for example touch and slide the displayed command regions, and see the updated command regions being dynamically updated on the screen.

Once a specific calibration is accepted, the command regions can become fixed, until a subsequent editing process is invoked. The calibration process can be done through a different state of the system, on application launch, or any other method that can be invoked by the user, to inform the system that calibration will be executed. In other embodiments, the system may perform calibration each and every time the user places a hand on the pad, in which case the calibration is never fixed. In other embodiments, the system may dynamically adjust the calibrated command regions as the user interacts with the system, as mentioned above.

The example described above is an almost fully automated process for identifying the hand and fingertips and assigning associated command regions. However, the invention is not limited to this example. For example, the application can simply step the user through a process of tapping each finger one-by-one in response to requests for each particular finger (i.e. thumb, index finger, etc.). Moreover, it is not necessary to identify each specific finger in all embodiments. For example, embodiments can merely identify fingers in a sequence from right to left, and not identify all fingers specifically.

As noted above, command regions can be any shape (circular, elliptic, irregular shaped). They can be much bigger than the contact area or elongated and oriented in such a way as to allow the user's finger to move up or down (or slightly towards the center of the hand) on the device and still be in contact with the command region.

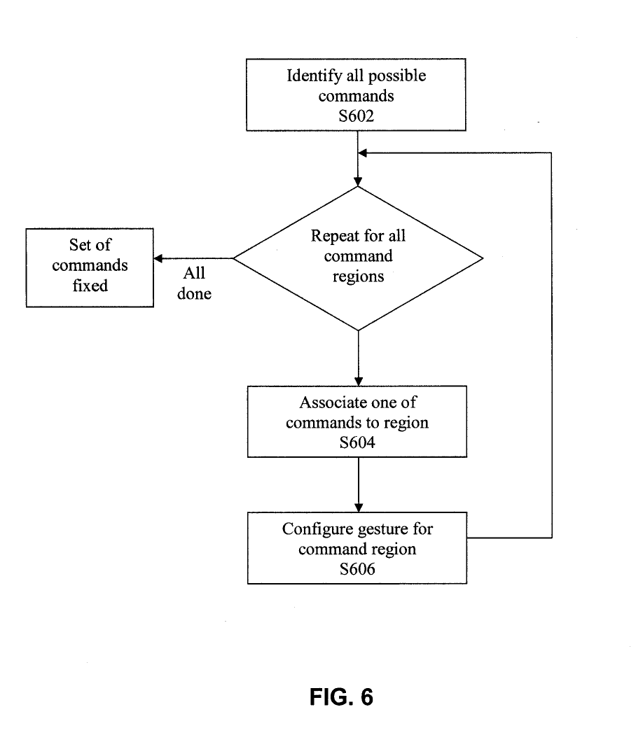

Having identified all fingers and fixed a set of corresponding command regions, an example method of associating commands with fingers is described below in connection with the flowchart illustrated in FIG. 6.

As shown in FIG. 6, a first step S602 includes identifying the set of all possible commands that can be used. In one example, the set can be fixed or predetermined (e.g. in embodiments where the application on pad device 102 is configured for a particular client application on host device 106). In other examples, the set of commands can be variable and downloaded from the client application by request via connection 108. For example, many applications (e.g. Adobe Photoshop) have a set of published commands, as well as APIs to interact with them.

In a next step S604, the application can interact with the user to determine which of downloaded commands to associate with each command region. This can be done on a simple one-by-one prompt basis, along with allowing the user to select a command from a menu, list, etc. Alternatively, this can be done iteratively in groups. For example, the application can allow multiple sets of commands that are associated with each finger, that can be accessed through different modes. For example, the client application can have multiple related “Edit” commands, and the user can associate certain of these “Edit” commands to each finger. The client application can also have multiple related “View” commands, and the user can associate certain of these “View” commands to each finger. The application can further provide a mechanism to switch between these different sets of commands, either through a separate menu control (e.g. a button or control in a corner of the pad) or with a command associated with one of the command regions. For example, in operation, a swipe on the bottom or side of the touchpad can cause the system to update the command regions so that a different set of commands is associated with them.

Even with such multiple sets, the application can also allow one or more command regions to be “locked” with a fixed command association. For example, the thumb can be assigned an “Undo” command that is active in all modes, even when commands associated with other fingers are changed. It should be appreciated that various additional alternatives and combinations are possible. Moreover, it is also possible to allow users to define groups of related commands or have groups preconfigured and automatically enabled based on state of the client application.

It should be noted that in alternative embodiments, the application itself can automatically predetermine the commands associated with each command region.

It should be further noted that a “command” associated with a command region can actually be a combination of two or more commands or “sub-commands” of the client application that the user can configure to be executed using a single gesture.

In a next step S606, the application can allow the user to change/configure gestures to activate each of the set of commands associated with some or all of the command regions (e.g. tap, reverse tap, swipe, etc.). This step is not necessary in all embodiments, however. For example, some embodiments can only allow a specific gesture to be used (e.g. tap) for all or certain types of commands.

As set forth previously, there can be any number of command regions to which commands are assigned. There can be a one-to-one mapping for each finger, there can be more than one per finger, or there can be less when some fingers are ignored for example. The actual number and configuration of the regions is something that the user can preferably control. The position and number of command regions can be fixed (e.g. calibrated once and on-demand by the user), automatic (e.g. every time a user places a hand on the pad, the invention can reconfigure the number and shape of the command regions) or adaptive (i.e. dynamic, where the invention will update the command region positions and shapes to adjust to the user's interactions with the system).

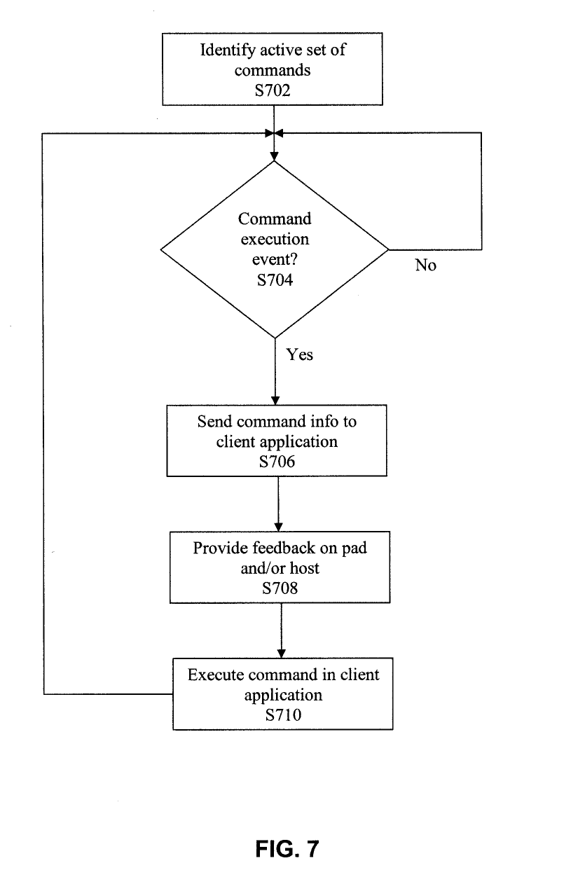

An example method of operating using commands is now described in connection with the flowchart illustrated in FIG. 7.

In step S702, the application identifies the currently active set of command regions, associated commands and gestures. This may not be necessary when there is only one set of commands and gestures. However, this step is preferable where there are multiple sets of commands and/or gestures associated with the command regions.

In some embodiments, the current set of commands may depend on the current client application being used or the current state of a client application. For example, when the client application enters an “Edit” mode with certain associated commands, this information can be sent to the pad application, and the pad application can update the command regions with the current active commands associated with that mode. In other embodiments, the current set of commands is configurable by the user on the client application. In other embodiments, the current set of commands is configurable on the pad application. In yet other embodiments, the current set of commands may depend on which fingers are touching the device and if some of the command regions are locked.

In step S704, the application 320 waits for a “command execution event.” For example, the application is notified of the occurrence of tap/clicks or other gestures (can be custom gestures) when they are registered on the touchpad by iOS. The application determines whether the event occurred in one of the active command regions, and if the gesture is a type configured for that command region. If so, the gesture is a “command execution event.” Otherwise, it is ignored.

It should be noted that some touch events (e.g. taps) can be discerned directly from system level events such as those provided by iOS. However, some touch events can be customized based on several different system level events (e.g. a reverse tap, which is a prolonged touch followed by a lift). In such cases, the application may need to monitor a certain sequence of system level events to determine whether they collectively form a gesture that activates a command.

In step S706, application 320 sends the command information to host device 106 via the particular connection 108. For example, the information can be sent over a Wi Fi connection.

In step S708, application 320 can provide feedback of a command execution (or failure). For instance, the system can provide visual cues on the screen of pad device 102. Visual cues can also be provided on the host device 106. Audio feedback can also be provided to indicate successful command execution or failure to execute, (on the pad device 102, the host device 106 or both).

In step S710, the associated command is provided to client application, which can then perform the associated task. For example, where the associated command is an “Undo” command, the last operation on the client application can be undone.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A method comprising:
sensing locations of a plurality of contact points between portions of a hand and a touchpad;
forming command regions around the sensed locations; and
assigning commands to be executed when the hand makes gestures in the command regions.

2. A method according to claim 1, further comprising:
sensing a gesture made in one of the command regions; and
causing one of the assigned commands to be sent to a remote device in response to the sensed gesture.

3. A method according to claim 2, wherein causing includes:
identifying the one command as being associated with the command region in which the gesture was sensed.

4. A method according to claim 2, wherein causing includes:
determining a type of the sensed gesture; and
identifying the one command as being associated with the determined type of gesture.

5. A method according to claim 1, further comprising forming one or more command regions in addition to the sensed locations which can also be accessed by the portions of the hand.

6. A method according to claim 1, further comprising:
automatically determining which of the sensed locations corresponds to a thumb of the hand.

7. A method according to claim 1, further comprising:
automatically identifying which fingers of the hand respectively correspond to certain or all of the sensed locations.

8. A method according to claim 1, further comprising:
automatically determining whether the hand is a right or left hand based on the sensed locations.

9. A method according to claim 1, further comprising:
allowing a user to change one or more of a size, shape and position of the command regions.

10. A method according to claim 1, further comprising:
dynamically adjusting the command regions over time according to one or both of sensed hand positions and sensed hand gestures.

11. A method according to claim 1, wherein assigning includes:
assigning a first set of commands to the command regions;
assigning a second different set of commands to the command regions; and
providing a mechanism to switch between the first and second sets of commands.

12. A method according to claim 11, wherein the first and second sets comprise at least one common command, the method further comprising locking one of the command regions to the common command.

13. A method according to claim 2, wherein the portions of the hand comprise fingertips.

14. A method according to claim 13, wherein the gestures comprise fingertip taps.

15. A method according to claim 13, wherein the gestures comprise fingertip swirls.

16. A method according to claim 13, wherein the gestures comprise fingertip swipes.

17. A system comprising:
a touchpad;
a display overlying the touchpad; and
a touchpad application that is adapted to:
sense locations of a plurality of contact points between portions of a hand and the touchpad;
form command regions around the sensed locations; and
assign commands to be executed when the hand makes gestures in the command regions.

18. A system according to claim 17, further comprising a remote device, wherein the touchpad, display and touchpad application are all incorporated in a pad device separate from the remote device, and wherein the touchpad application is further adapted to:
sense a gesture made in one of the command regions; and
cause one of the assigned commands to be executed on the remote device in response to the sensed gesture.

19. A system according to claim 18, wherein the commands are associated with a client application executing in the remote device.

20. A system according to claim 17, wherein the touchpad application is further adapted to cause the command regions to be displayed on the display.
